(19) United States
(12) Patent Application Publication
(10) Pub. No.: US 2020/0302367 A1
(43) Pub. Date: Sep. 24, 2020

(54) HIERARCHICAL PERFORMANCE METRICS

(71) Applicant: ServiceNow, Inc., Santa Clara, CA (US)

(72) Inventors: Niki Manubhai Patel, San Diego, CA (US); Lloyd Gomes, San Jose, CA (US); John Alan Botica, Escondido, CA (US); Caitlin Anne Markham, La Jolla, CA (US)

(21) Appl. No.: 16/358,327

(22) Filed: Mar. 19, 2019

(51) Int. Cl. G06Q 10/06; G06F 3/0482

(52) U.S. Cl. CPC G06Q 10/06393; G06F 3/0482

(57) ABSTRACT

The present disclosure relates to improving the efficiency of certain enterprise operations by generating and efficiently displaying performance data for a service provider (e.g., vendor). In some embodiments, the performance may be displayed with different granularities of the data on a dashboard. For example, the performance data may be displayed with a performance score, where the score is based on a weighted total of different combinations of the performance data.

### BACKGROUND

The present disclosure relates generally to providing quantitative data of performance metrics at varying levels of granularity to inform certain enterprise operations.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions. For example, organizations may use cloud computing approaches to store performance metric data (e.g., metrics and/or performance data) related to the quality of services and/or products provided by service providers (e.g., vendors).

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach is generally directed to improving the efficiency of certain enterprise operations by generating and efficiently displaying performance data for a service provider (e.g., vendor). In some embodiments, the performance may be displayed with different granularities of the data on a dashboard. For example, the performance data may be displayed with a performance score, where the score is based on a weighted total of different combinations of the performance data. Moreover multiple additional performance scores may be displayed that provide an increased level of detail to further inform employees above the quality of a vendor. In some embodiments, the performance score and/or the additional performance score may include an indication of whether the performance score and/or the additional performance score has improved over time based on a comparison to a performance score and/or the additional performance score from an earlier date. By providing more levels of detail regarding the quality of a products and/or service provided by the vendor, employees may more efficiently select service providers that provide products that are used in certain enterprise-related operations or negotiate effective contracts. As such, providing a variety of levels of detail related to the service provider may improve the efficiency of the enterprise as a whole.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is an example screenshot of a workspace provided by a display of a client device of FIG. 1 that displays a list of service provider and associated performance data;

FIG. 5 depicts a dashboard displaying different levels of performance data, in accordance with aspects of the present disclosure;

FIG. 6 depicts the dashboard of FIG. 5 with additional levels of performance data, in accordance with aspects of the present disclosure;

FIG. 7 depicts the dashboard of FIG. 5 with further levels of performance data, in accordance with aspects of the present disclosure;

FIG. 8 depicts a dashboard showing descriptions of a type of performance data shown in the dashboard of FIG. 5, in accordance with aspects of the present disclosure;

FIG. 9 depicts the dashboard of FIG. 8 with a service window providing additional information related to the type of performance data, in accordance with aspects of the present disclosure;

FIG. 10 depicts a service window that may be displayed in response to a user selection of a selectable item in the service window of FIG. 9, in accordance with aspects of the present disclosure.

FIG. 11 depicts a historical breakdown window associated with a selectable item of the dashboard shown in FIG. 7.

FIG. 12 shows an example of a tab that may be displayed in the dashboard shown in FIGS. 5-7;

FIG. 13 shows an additional example of a tab that may be displayed in the dashboard shown in FIGS. 5-7; and

FIG. 14 shows an additional example of a tab that may be displayed in the dashboard shown in FIGS. 5-7.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, “performance data” is data indicative of evaluated metrics relating to a service provider, such as an evaluation by an employee or a measure of the service provider's ability to provide deliverables (e.g., services and/or products), such as whether or not the service provider fulfilled a contract (e.g., in a timely manner), customer service satisfaction, quality of products and/or services, availability of the service provider, stability (e.g., variance in the metrics), and the like. As used herein, “vendor performance analytics” refers to analyzed performance data.

Enterprises may utilize products provided by different service providers (e.g., vendors) to accomplish a variety of operations. The employees tasked with purchasing a product and/or service may compare multiple service providers when deciding on which service provider to purchase the product and/or service from. For example, vendor managers and performance analysts may compare vendor performance analytics such as custom service experience, pricing, number of contracts, and the like, to inform the decision of which vendor to purchase the product from. Current implementations for providing performance analytics are inefficient as the vendor managers and/or the performance analysts may manually search for, gather, and calculate performance analytics from approximately 20,000 vendors for regular meetings (e.g., annual, quarterly, monthly, weekly meetings and the like) as well as for ad-hoc requests. In addition, current implementations do not surface analytics in way that is meaningful to the vendor manager or aligns with company objectives.

The present approach is generally directed to the efficient and effective dissemination of vendor performance analytics by displaying a hierarchal organization of vendor performance analytics referred to as levels of performance. More particularly, the present approach is directed to presenting quantitative information related to a vendor and/or service provider at varying levels of granularity. For example, the hierarchal organization may include a first level of performance and may include an overall performance score associated with the vendor that is generally calculated based on retrieved performance data from a database. The hierarchal organization may include one or more second levels of performance that breakdown components (e.g., vendor performance scores) making up the first level of performance. Additionally, the hierarchal organization may include third levels of performance that breakdown the components making up each second level of performance. In some embodiments, the hierarchal organization may include additional levels of performance that each generally further breakdown a respective previous level of performance with increasing levels of granularity. In some embodiments, the various levels of performance may be displayed on a dashboard. As such, the vendor dashboard may display broad and more detailed descriptions of the performance analytics for each vendor. In some embodiments, the dashboard may include a window that displays performance analytics of each vendor over time. In this manner, a vendor manager may efficiently determine a favorable vendor to purchase a product from based on a variety of performance analytics.

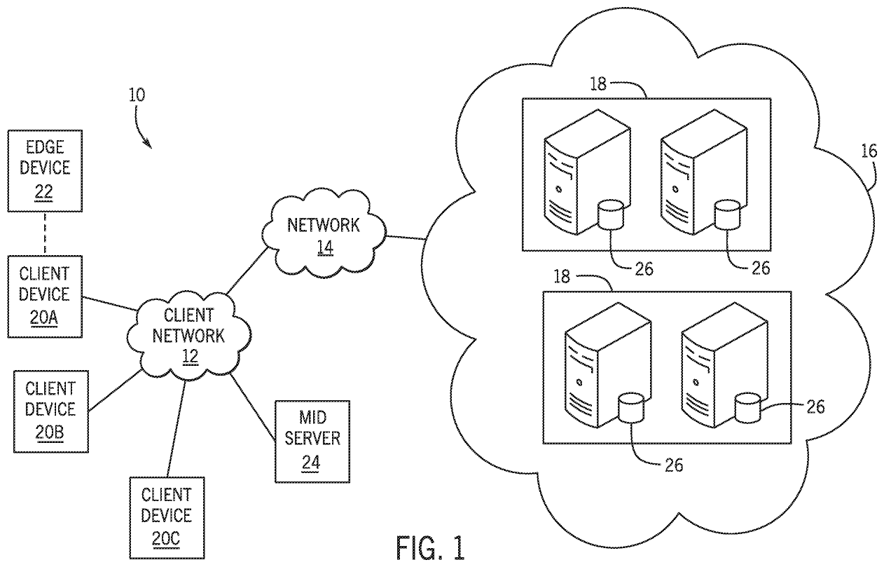

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

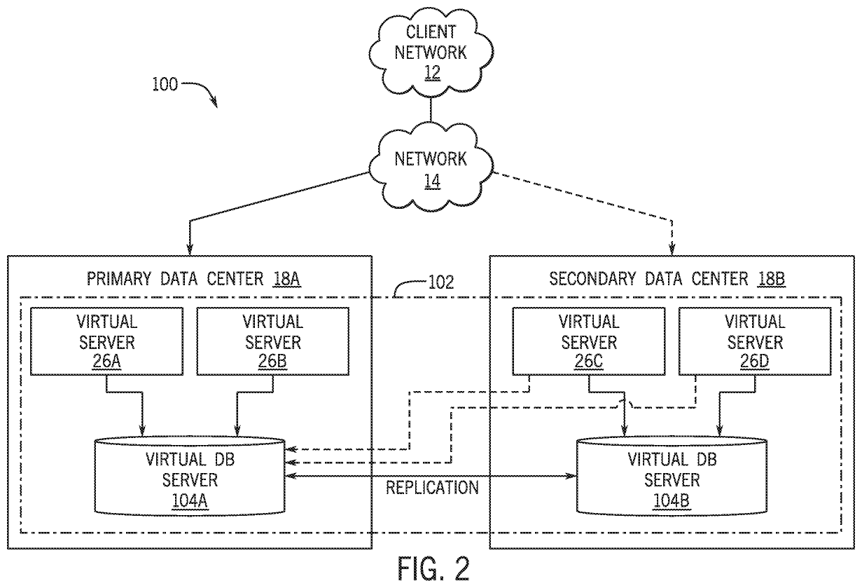

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

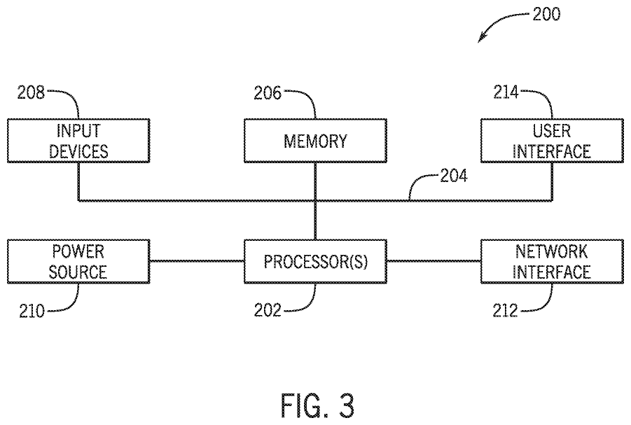

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

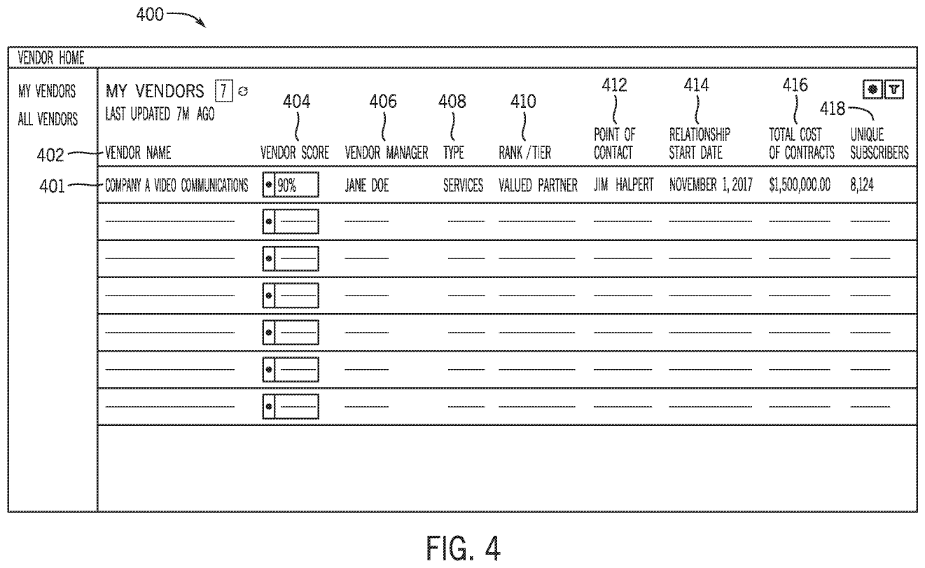

FIG. 4 is an example screenshot of a workspace provided by a display of a client device of FIG. 1 that includes a vendor record table 400. The vendor record table 400 contains multiple vendor records 401 with various fields such as a vendor identity field 402 and vendor data fields 404, 406, 408, 410, 412, 414, 416, and 418 that hold data associated with the vendor identified by the identity field 402. In the illustrated embodiment of the vendor record table 400, each vendor record 401 or a field of the vendor record 401, such as the identity field 402, may be a selectable link or include a selectable soft button that a user may select to retrieve additional information regarding the vendor represented in the selected vendor row. Upon receiving a user selection of a vendor record 401, a vendor dashboard that may include various levels of performance information related to the vendor of the selected vendor record 401 may be displayed on a client device 20.

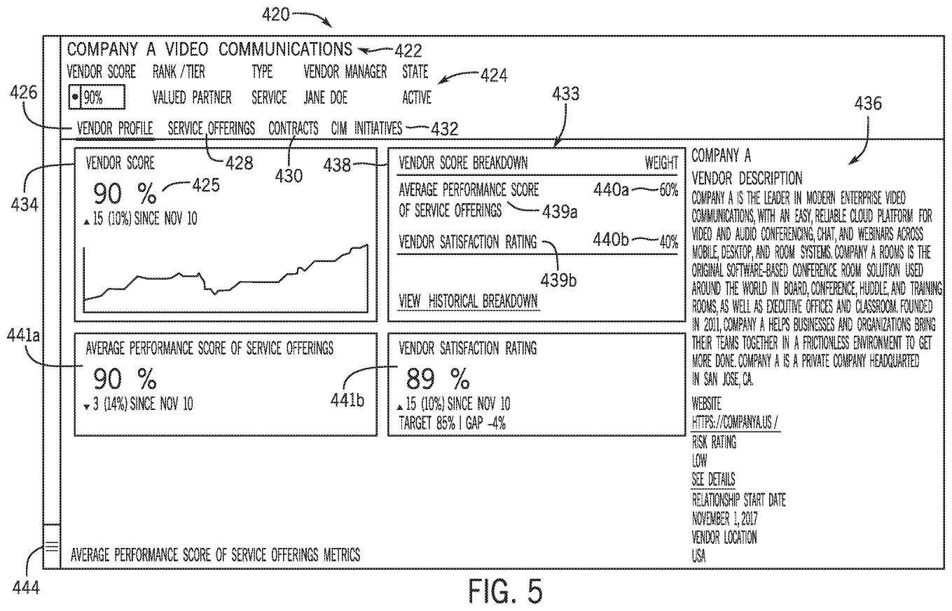

To illustrate this, FIG. 5 shows an example of a vendor dashboard 420. It should be noted that the vendor dashboard 420 may be displayed on the client device of FIG. 1. Further, certain windows and/or tabs may be instructed to be displayed as a result of, for example, a user selecting certain selectable features (e.g., soft buttons, icons, links, tabs, and the like). In some embodiments, the vendor dashboard 420 may be configured to be displayed on a mobile device.

The illustrated embodiment of the vendor dashboard 420 includes a vendor title 422, a vendor summary ribbon 424, vendor information tabs 426, 428, 430, and 432, a performance window 433, and a vendor information window 436. As discussed further below, the vendor dashboard 420 generally shows a variety of levels of performance data in an efficient manner to improve selection of vendors. For example, the vendor dashboard 420 may provide a summary of the performance of a vendor, a performance score associated with the performance, and various breakdowns on the performance score. In some embodiments, the various breakdowns of the performance score may be organized spatially, such that less granular information is presented initially, and increasingly granular information is present later (e.g., positioned low in the window) or though access of tabs.

In the illustrated vendor dashboard 420, the level of detail of information related to the vendor increases vertically downward. It should be noted that any spatial arrangement of the data could be used, such as left to right, or having the level of detail decreasing vertically downward. The vendor summary ribbon 424 may provide a summary of information regarding the vendor (e.g., indicated by the title) such as a quantified performance score 425, a qualitative vendor rank or tier, the type of vendor, a vendor managers name, and a status. In the illustrated vendor dashboard 420, information tabs 426, 428, 430, and 432 are disposed below the summary ribbon 424. The information tabs 426, 428, 430, and 432 may provide more detail regarding certain information regarding the vendor that is displayed in the summary ribbon 424.

For example, when the information tab 426 is displayed and/or selected, a performance window 433 is displayed. The illustrated performance window 433 includes a first level performance card 434 displaying a performance score 425 (e.g., ‘90%’), a time-based performance change (e.g., ‘up 15 (10%) since November 10), and a graph showing the change of the performance score 425. In general, the performance score 425 is a quantitative evaluation of the quality and/or health of a vendor that is determined based on data (e.g., stored in the database 104).

The illustrated performance window 433 also includes a performance score breakdown card 438 that generally describes factors that contribute to the performance score 425. The performance score 425 in the illustrated performance window 433 is calculated based on two second levels of performance 439a (e.g., ‘average performance score of service offerings’) and 439b (e.g., ‘vendor satisfaction rating’) and a respective predetermined weight 440a and 440b for each of the second levels of performance. In some embodiments, the predetermined weight and/or the types and number of second levels of performance may be assigned by a vendor manager based on, for example, performance characteristics indicative of a reliability of a vendor. In some embodiments, the users may configure the levels of performance.

In general, each level of performance may have an associated score that is calculated based on a combination of data (e.g., performance data) from one or more additional levels of performance. The illustrated performance window 433 includes second level performance cards 441a and 441b that correspond to the second levels of performance 439a and 439b displayed in the performance score breakdown card 438. In general, a second level performance card 439 may display quantitative and/or qualitative scores indicative of the second level performance. For example, in the illustrated performance window 433, the second level of performance 439a has a quantitative score of 90% shown in the second level of performance cards 441a and the second level of performance 439b has a quantitative score of 89% shown in the second level of performance cards 441b. Additionally, each second of level performance card 441a and 441b displays a change, such as a percentage or value change, of the displayed qualitative score from some earlier date (e.g., ‘November 101’ as shown) to inform a vendor manager about, for example, trends in the quality of the vendor associated with the performance card 441.

In FIG. 5, the quantitative scores displayed in the second level of performance cards 439a and 439b are combined with the weights 440a and 440b to produce the performance score 425. In this manner, a vendor manager viewing the illustrated performance window 433 can make an assessment on the quality and/or performance of the vendor indicated by vendor title 422. Additionally, the vendor manager may view additional cards to gain increasingly detailed or granular information regarding the vendor indicated by the vendor title 422 by viewing the first level performance cards and/or any number of the second level of performance cards 441.

The vendor information window 436 generally provides a description of the vendor's company, contact information, and certain contract and service offering information. For example, the illustrated vendor information window 436 shown in FIG. 5 displays a summary description of the vendor, a vendor website address, a risk rating, a start date, and a general vendor locations (e.g., country). The vendor information 436 may also include points of contact for the associated vendor. As shown in the illustrated vendor dashboard 420, the vendor information window 436 is provided as a column on a right horizontal position of the vendor dashboard. However, it should be noted that the vendor information 436 may be included in other positions or, in some embodiments, accessible via user selection of a link or tab.

In some embodiments, the vendor dashboard 420 may include more information than could display on a screen such that the vendor manager can read it. Additionally or alternatively, the vendor dashboard 420 may have each level of performance cards (e.g., the first level of performance card 434, the second level of performance card(s) 439, and any additional level of performance cards) organized vertically or horizontally such that one level of performance card is viewable at a time. In any case, the vendor dashboard 420 may include a scroll bar 444 to facilitate viewing the rest of the vendor dashboard 420 that may include features organized in a horizontal or vertical manner. Alternatively, the processor 202 may be configured to scroll through the vendor dashboard based on interaction between a user and a touchscreen display.

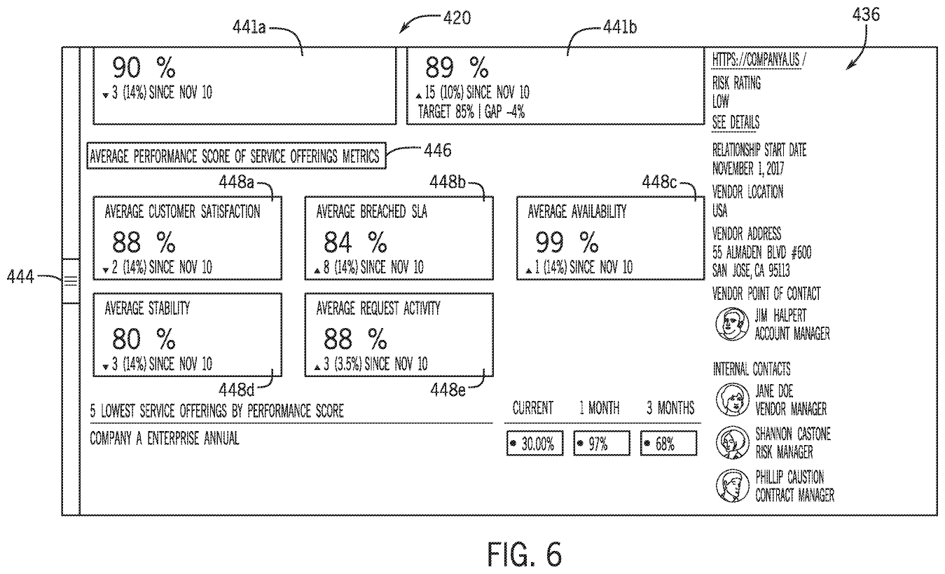

FIG. 6 depicts the dashboard 420 of FIG. 5 with third level of performance cards 448 for the second level of performance card 441a as indicated by the title field 446. In the illustrated performance window 433 of the dashboard 420, five third level performance cards 448a, 448b, 448c, 448d, and 448e are shown for the second level of performance card 441a. It should be noted that the performance window 433 may display third level of performance cards 448 for the second level of performance card 441b in addition to or alternatively, for example, as a result of a selection of widget, button, and the like by a user. In any case, the third level of performance cards 448 may include an associated performance score, a change in the score since a previous date, and other information that generally indicates the measured performance of the respective third level of performance.

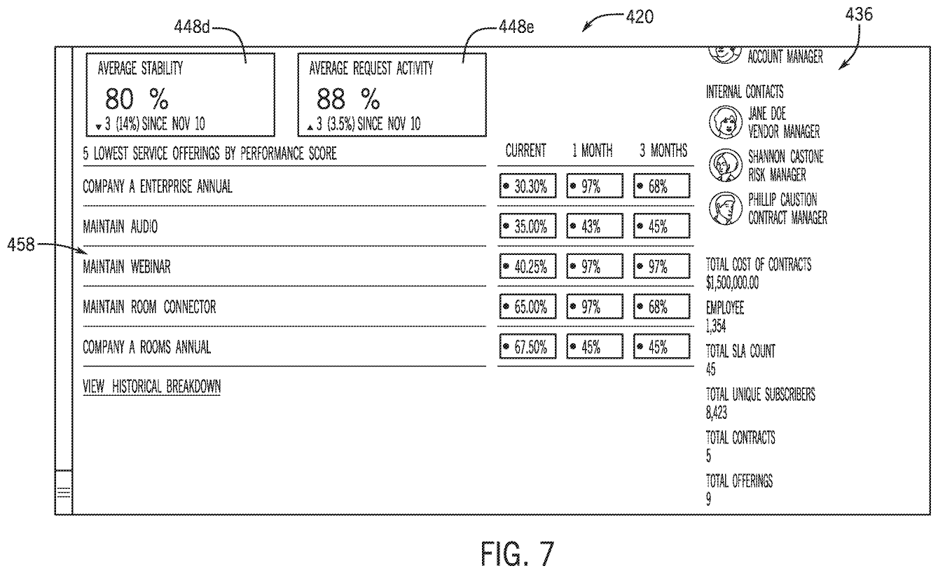

In some embodiments, a subset of the performance data having the highest and/or lowest scores may be displayed on the performance window 433, which may better inform a vendor manager on the quality and/or health of the vendor associated with the performance window 433. FIG. 7 depicts the dashboard of FIG. 5 with a ranked performance window 458 that shows a current and past performance over a time range, as well as a soft button 459 that may provide a breakdown of the lowest and/or highest performance data.

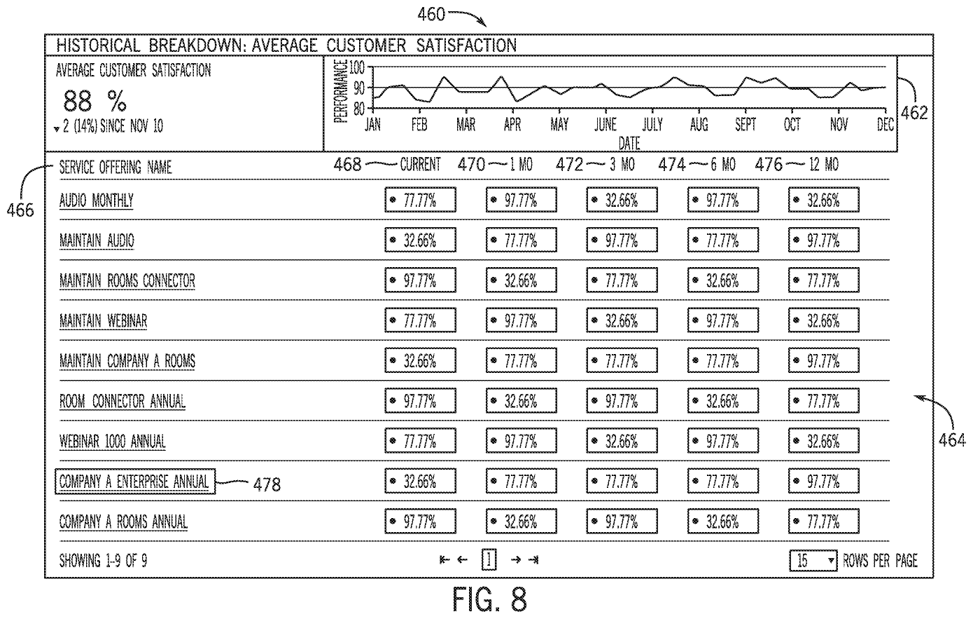

In some embodiments, the vendor manager may desire further granular data regarding performance data indicated in a performance card. FIG. 8 depicts a historical data window 460 associated with the vendor performance data presented in the third level of performance card 448 shown in FIG. 6. The illustrated historical data window 460 shows a summary graph 462 that depicts the performance score indicated in the performance card 448 over time. Further, the historical data window 460 may include performance list 464, which may include records of various relevant scores identified in the field 466. For example, the illustrated historical data window 460 relates to an “average customer satisfaction” and the field 466 of the performance list 464 lists different services and a rating of the service on different time fields 468, 470, 472, 474, and 476. The rating associated with each time field 468, 470, 472, 474, and 476 may each include an indication of the change in the rating from a previous time. In some embodiments, the indication may be a color indication based on thresholds defined by the customer (e.g. 80-100%=green, 70-80%=yellow, <60%=red). It should be noted that the colors may correspond to different thresholds in the ratings. In this manner, a vendor manager may determine a vendor's quality based on observed trends in performance of the vendor.

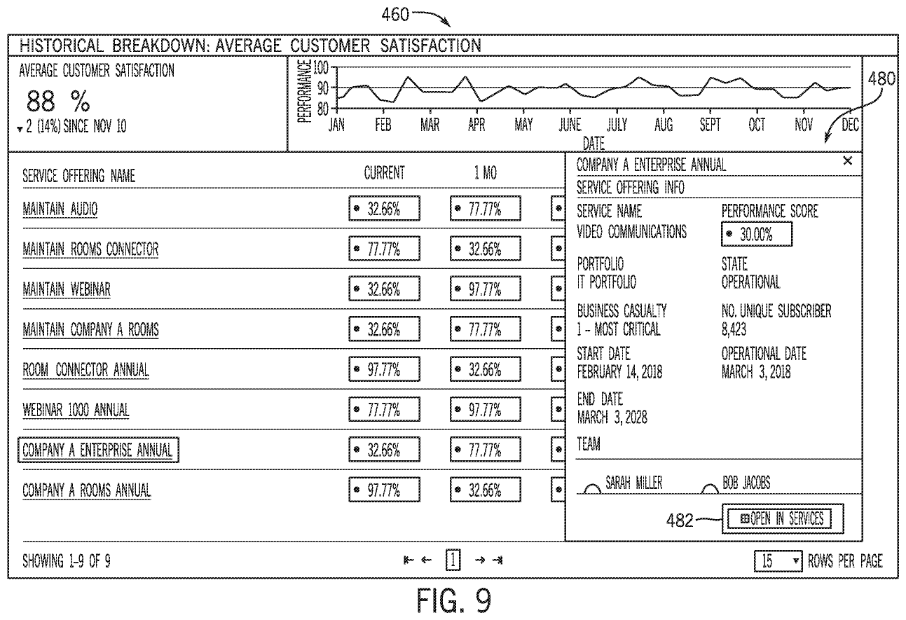

Moreover, each service provided in the list may be a selectable item. As a result of an employee selecting an item from the performance list 464, additional data related to the item may be displayed. For example, FIG. 9 depicts a detailed service window 480 that may include further granular information regarding the item from the performance list.

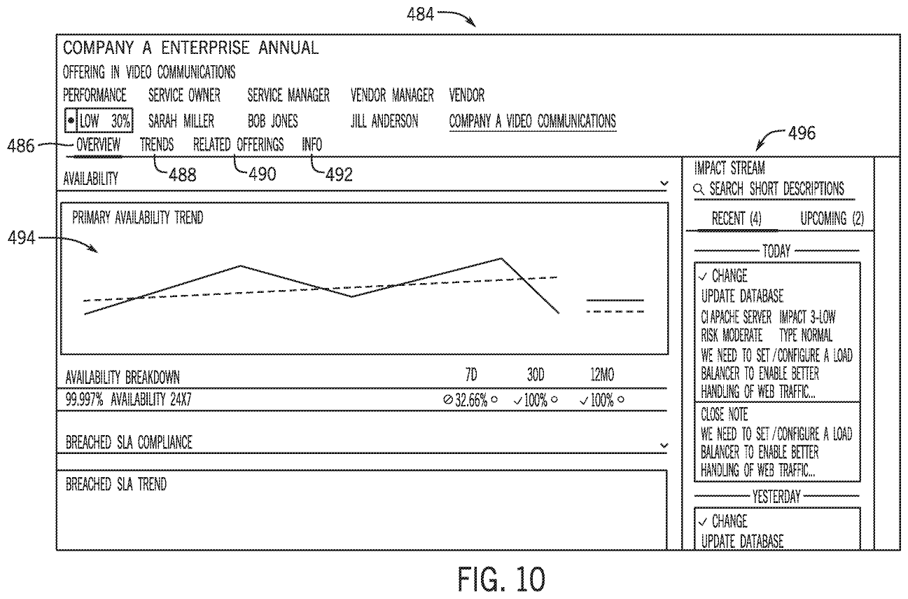

Further still, a vendor may wish to access more granular information. The illustrated detailed service window 480 includes a selectable item 482 that may provide a service window 484, as shown in FIG. 10. In some embodiments, the selectable item 482 may enable a user to access different applications that may have relevant vendor information. The illustrated service window 484 includes one or more tables 486, 488, 490, 492 that provide different levels of information (e.g., ‘overview’, ‘trends’, ‘related offerings’ and ‘information’). Additionally, the service window 484 may include a graph 494 that illustrates a trend of a metric associated with the service window 484. Further, the service window 484 may include a task window 496 that may displaying upcoming or recent changes relevant to the metric associated with the service window 484.

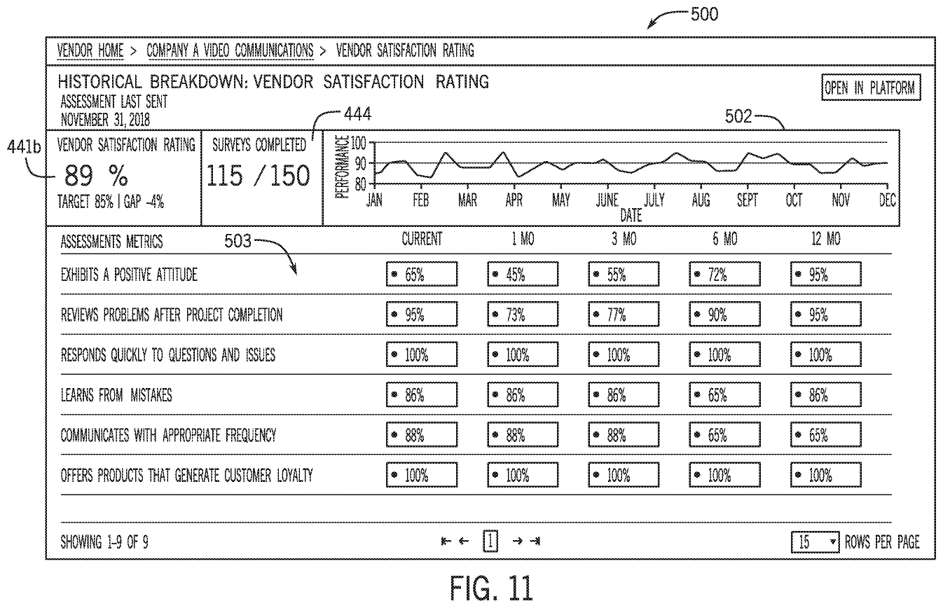

Referring briefly to FIG. 7, the ranked performance window 458 may include a soft button 459 that may display time-related performance data associated with, for example, the lowest performance scores and/or data. Turning to FIG. 11, FIG. 11 shows a historical breakdown window 500 that may be displayed as a result of selecting the soft button 459. The historical window 500 generally includes performance scores, performance data, and time-related performance data associated with a certain level of performance score. The illustrated historical window 500 shows the performance score associated with the second level of performance card 441b, a number of surveys completed 501, and a time-related performance table 503. In this manner, a vendor manager may assess the quality and health of a vendor based on their lowest performing metrics, or performance data contributing to a performance score.

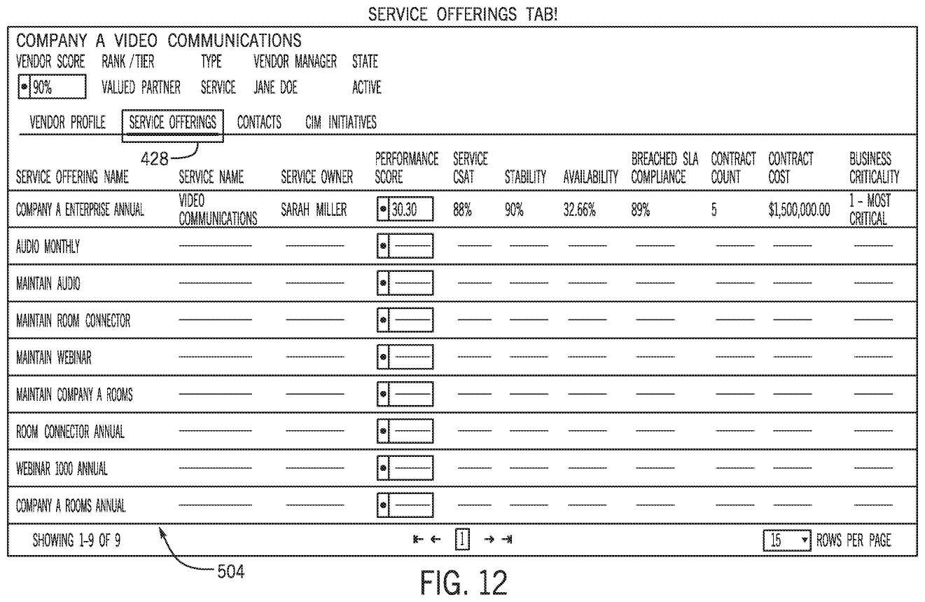

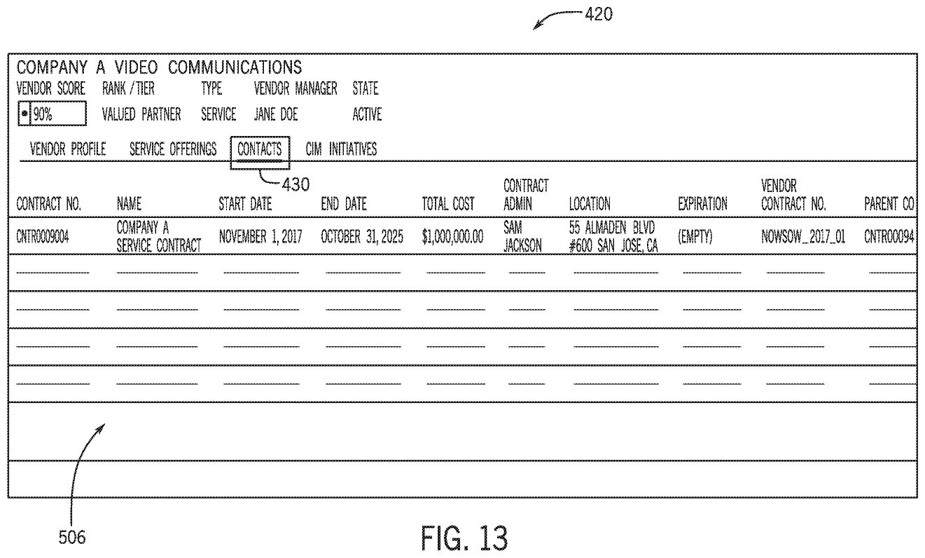

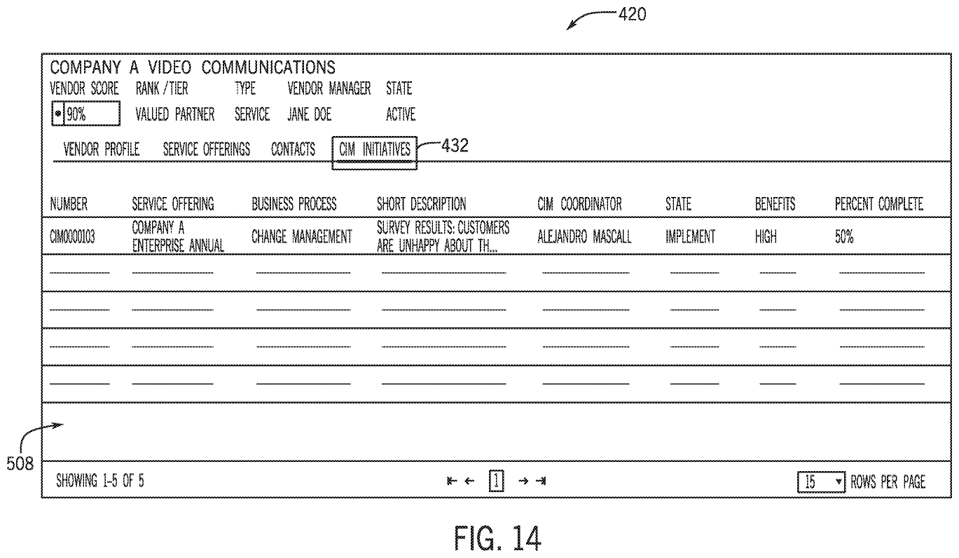

Referring briefly to FIG. 7, the illustrated vendor dashboard 420 includes information tabs 426, 428, 430, and 432. While the content that may be shown in information tab 426 was shown in FIGS. 4-6, examples of content that may be shown in the information tabs 428, 430, and 434 are shown in FIGS. 12-14. For example, FIG. 12 shows a service offering window 504 that may be displayed in response to a user selection of the information tab 428. Additionally, FIG. 13 shows an example of a contract window 506 that may be displayed in response to a user selection of the information tab 430. Furthermore, FIG. 14 shows an example of a Continual Improvement Management (CIM) window 508 that may be displayed in response to a user selection of the information tab 432.

As discussed herein, the present approach is generally directed to the efficient and effective dissemination of vendor performance analytics by displaying a hierarchal organization of vendor performance analytics referred to as levels of performance. In some embodiments, the hierarchal organization may include additional levels of performance that each generally further breakdown a respective previous level of performance with increasing levels of granularity. In some embodiments, the various levels of performance may be displayed on a dashboard. As such, the vendor dashboard may display broad and more detailed descriptions of the performance analytics for each vendor. In some embodiments, the dashboard may include a window that displays performance analytics of each vendor over time. In this manner, a vendor manager may efficiently determine a favorable vendor to purchase a product from based on a variety of performance analytics. Further, they enable the contract management team to negotiate more effective contracts based off of historical performance. Or they reallocate penalties should the vendor breach a contractual performance metric based off of historical performance.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A workspace system comprising:
a non-transitory, machine-readable medium; and
one or more processors configured to execute instructions stored in the non-transitory, machine-readable media to perform operations comprising:
displaying a list of vendor records;
receiving a selection of a vendor record from the list of vendor records;
displaying a first level of performance data on a window of a dashboard;
displaying one or more second level of performance data, wherein the second level of performance data provides a breakdown of the first level of performance data, and wherein the first level of performance data and the second level of performance data are displayed on the same window.

2. The system of claim 1, wherein the first level of performance, the second level of performance, or both, are displayed in a card format.

3. The system of claim 1, wherein the first level of performance data is displayed in a first vertical position, and wherein the second level of performance data is displayed in a second vertical position.

4. The system of claim 1, wherein the performance data is based on evaluation data for a vendor.

5. The system of claim 1, wherein the operations comprise:
displaying a performance window view of a second level of performance data in response to a user selection of the one or more second level of performance data.

6. The system of claim 5, wherein the performance windows comprises time-related performance data.

7. The system of claim 6, wherein the time-related performance data comprises a summary graph.

8. The system of claim 1, wherein the first level of performance data comprises a first level performance score, and wherein the second level of performance data comprises a second level performance score.

9. The system of claim 1, wherein the first level of performance data, the second level of performance data, or both includes an indication of a change of the performance score associated with the performance data from a previous performance score.

10. The system of claim 1, comprising displaying a vendor description while displaying the first level of performance data and the second level of performance data.

11. The system of claim 1, wherein the operations comprise:
displaying a third level of performance data at a third vertical position, wherein the second level of performance is determined based on the third level of performance data.

12. A tangible, non-transitory, machine-readable medium, comprising machine-readable instructions, wherein the machine-readable instructions, when executed by one or more processors cause the one or more processors to:
retrieve performance data;
identify one or more performance scores based on the performance data;
identify an overall performance score based on the one or more performance scores; and
display a window comprising a first level vendor performance card and a second level vendor performance card, wherein the first level vendor performance card comprises an overall performance score that is calculated based on one or more performance scores depicted in the second level vendor performance card.

13. The tangible, non-transitory, machine-readable medium of claim 12, wherein the overall performance score is calculated based on predetermined weights assigned to each of the one or more performance scores of the second level vendor performance card.

14. The tangible, non-transitory, machine-readable medium of claim 13, wherein the predetermined weights are displayed in a card layout that is separate from the first level vendor performance card.

15. The tangible, non-transitory, machine-readable medium of claim 12, wherein the window is scrollable and configured to be displayed on a mobile device.

16. The tangible, non-transitory, machine-readable medium of claim 12, wherein the instructions, when executed, cause further acts to be performed comprising:
displaying a vendor information window within the window that includes a description of the vendor.

17. A system comprising:
a non-transitory, machine-readable medium; and
one or more processors configured to execute instructions stored in the non-transitory, machine-readable media to generate a graphical user interface, wherein the graphical user interface comprises:
a workspace comprising a vendor summary ribbon and a vendor performance window, wherein:
the vendor summary ribbon is configured to provide a summary of vendor-related information;
the vendor performance window is configured to display a first level vendor performance card, a vendor score breakdown card, and one or more second level vendor performance cards, wherein the one or more second level vendor performance cards each display a second level performance score, wherein the vendor score breakdown card displays a weighted value associated with each of the second level performance scores, and wherein the first level vendor performance card displays a vendor score based on the weighted values and the second level performance scores.

18. The system of claim 17, wherein the first level vendor performance card, the second level vendor performance card, or both, display time-related performance data indicative of a change in the vendor score, the second level performance scores, or both.

19. The system of claim 17, wherein the vendor performance window comprises a lowest performance window that displays lowest ranking performance data associated with at least one of the second level performance scores.

20. The system of claim 17, wherein the workspace comprises a vendor information window.
